(19) United States
(12) Patent Application Publication
(10) Pub. No.: US 2001/0038353 A1
(43) Pub. Date: Nov. 8, 2001

(54) Electromagnetic wave absorber

(76) Inventors: Junichi Toyoda, Tokyo (JP); Katsumi Okayama, Kanagawa (JP); Sakan Iwashita, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/778,706

(22) Filed: Feb. 7, 2001

(30) Foreign Application Priority Data
Feb. 8, 2000 (JP) P2000-030529

(51) Int. Cl. H01Q 17/00

(52) U.S. Cl. 342/1; 342/4

(57) ABSTRACT

There is provided an electromagnetic wave absorber in which uniformity, reproducibility and productivity are raised by forming a metal soft magnetic material flat plate, the surface of which is smoothed, of a regular shape disk or elliptical shape easily, at low cost, stably and certainly. In the electromagnetic wave absorber composed of a mixture of a magnetic material particle 21 and an organic binding material, the magnetic material particle 21 is constituted by a nucleus 22 made of organic material and a magnetic material film 23 formed on its surface.

### BACKGROUND OF THE INVENTION

1. Field of the Invention

The present invention relates to an electromagnetic wave absorber. More particularly, the invention relates to an electromagnetic wave absorber made of a mixture of a magnetic material particle and a resin material.

2. Description of the Related Art

An instrument has been miniaturized and the frequency thereof has been raised, and there has arisen a serious electromagnetic environmental problem such that a noise radiated or leaking from an electronic instrument of a printed board or the like or from a communication device or the like has a bad influence on other instruments, or an erroneous operation is caused by an electromagnetic wave from the outside. As a countermeasure against this, although such a method as to change the wiring pattern of a printed board or to use countermeasure parts has been adopted, there have been disadvantages that the design must be reconsidered, the costs of the parts are high, and a time required to make a product becomes long. On the other hand, an electromagnetic wave absorber which functions to absorb an unnecessary electromagnetic wave to convert it into heat, causes the noise itself to be reduced, so that it has become the main stream as means for attaining a stable function of an electronic instrument or a communication instrument.

However, in recent years, an equipment has been increasingly miniaturized, the packaging density of various semiconductor elements mounted on a substrate has been remarkably increased, and a space for the arrangement of the electromagnetic wave absorber for the countermeasure is decreased though the electromagnetic environment becomes worse. In order to solve this, it is necessary to raise the electromagnetic wave absorbing power of the electromagnetic wave absorber.

As this sort of electromagnetic wave absorber, conventionally, an electromagnetic wave absorber of a composite, which is formed by producing particles of spinel-type ferrite sintered body, hexagonal ferrite sintered body or flake-shaped metal soft magnetic material and by mixing the particles with resin, is put to practical use. Material parameters concerned with characteristics of this electromagnetic wave absorber are complex dielectric constant ε and complex permeability μ at a high frequency. Among these, in the electromagnetic wave absorber using a magnetic material, μ″ (imaginary part of the permeability, term of magnetic loss) of the complex permeability μ (=μ′−j μ″) concerns the electric wave absorption characteristics.

Although a magnetic material capable of coping with a frequency up to a high frequency is generally used for the electromagnetic wave absorber, it is necessary to raise μ″ as a physical constant for converting electromagnetic wave energy into heat at the frequency. Normally, a material of about 5 to 10 in the GHz band is used. As the electromagnetic wave absorber used for an electromagnetic wave absorbing sheet for an EMC (Electromagnetic Compatibility) countermeasure or for an electromagnetic interference suppressor sheet, a composite magnetic material in which spinel-type ferrite powder or flat soft magnetic material metal powder is mixed with resin has been developed by the present inventor et al.

The shape of the magnetic material powder is a flake shape, a flat shape, a resin shape or a fiber shape. When this is made a disk shape or an elliptical shape and the surface is made smooth, although anisotropy in an in-plane direction is deceased, anisotropy in a plane vertical direction is increased, so that the permeability is eventually increased. By this, high permeability up to a high frequency exceeding the Snoek limit (limit of rotating magnetization) can be obtained. As a method of forming such a disk-shaped magnetic material, a method of forming it from a thin film, a method of forming it from a spherical particle, and a method of smoothing its surface have been devised by the present inventor et al. and have been proposed.

FIG. 5 is a schematic explanatory view showing a method of forming a disk-shaped magnetic material from a thin film.

As shown in the drawing, a disk-shaped magnetic material is obtained by forming a thin film on a base film 1 through a mask 2 by sputtering, evaporation, CVD or the like. The drawing shows an evaporation method by an Ar beam 4, and a target 3 uses a material such as a Fe base magnetic material. First, molten metal is evaporated from the target 3 of the Fe base magnetic material through the mask 2 in which a pattern of a number of holes (not shown) are formed and is adhered to the base film 1.

Subsequently, the mask 2 is removed. By this, disk-shaped fine particles 5 of disk-shaped metal magnetic materials are adhered to the base film 1 and remain. The disk-shaped fine particles 5 are peeled off from the base film 1 to form the disk-shaped metal magnetic materials.

FIG. 6 is a schematic explanatory view showing a method of forming a disk-shaped magnetic material from a spherical powder particle.

First, spherical particles 7 are formed by an atomizing method or a chemical deposition method. In the chemical deposition method, metal salt of iron is reduced to deposit iron fine particles. In the atomizing method, molten metal is dropped or is blown by a nozzle into a high speed fluid of gas, water or the like, and fine particles are formed by the fluid during a cooling process. The diameters of the spherical particles 7 are suitably adjusted from several hundreds nm to several tens μm in accordance with design conditions of an electromagnetic wave absorber to be used and the formation can be made. Such spherical particles 7 are crushed by applying the physical force of a stamp mill 4 to form flat disk-shaped fine particles 5.

FIG. 7 is a schematic view showing a method of processing the powder magnetic materials, which are formed in FIGS. 5 and 6, by acid.

A flake-shaped magnetic material particle 6 with a surface on which irregularities or protrusions are formed is immersed in an acid solution so that the surface becomes smooth, and a circular flat plate magnetic material 9 having high permeability can be obtained.

However, in the case where the metal soft magnetic material is formed from the thin film as in FIG. 5, practical application is difficult in view of costs, and in the case where it is formed from the spherical powder particle as in FIG. 6, it is difficult, by microscopic irregularities, protrusions or the like, to form the flat metal soft magnetic material having a skin depth or less in which an electromagnetic wave can penetrate, and in view of reproducibility or mass productivity, both are not necessarily optimum forming methods. Besides, in the method of processing the flake-shaped powder by acid, the yield of complete circular powder is not necessarily high, and there is a problem also in the point of uniformity of shape.

### SUMMARY OF THE INVENTION

The present invention has been made in view of the above related art, and has an object to provide an electromagnetic wave absorber which is improved in uniformity, reproducibility, and productivity by forming a metal soft magnetic material flat plate, which has a smoothed surface, of a regular shape disk or elliptical shape easily, at low cost, stably and certainly.

In order to achieve the above object, the present invention provides an electromagnetic wave absorber which is made of a mixture of a magnetic material particle and an organic binding material and is characterized in that the magnetic material particle comprises a nucleus made of an organic material and a magnetic material film formed on its surface.

According to this structure, by forming the magnetic material particle by the nucleus made of the organic material and the magnetic material film formed on the surface, the nucleus of a regular shape disk shape or elliptical flat plate shape can be formed by a synthetic resin material or the like easily and at low cost, and by coating the surface of this nucleus with the magnetic material film, the surface of the magnetic material particle is smoothed and comes to have the regular shape disk or elliptical shape. By this, the permeability as the electromagnetic wave absorber is increased, and the uniformity, reproducibility, and productivity are raised.

A preferred structural example is characterized in that a thickness of the magnetic material film is a thickness of a skin depth or less.

According to this structure, an electromagnetic wave is certainly permeated into the magnetic material film and is absorbed.

A preferred structural example is characterized in that the mixture has a paste shape or a sheet shape.

According to this structure, it is possible to obtain a form which facilitates an actual use as the electromagnetic wave absorber.

### BRIEF DESCRIPTION OF THE DRAWINGS

FIG. 1s a partially cutaway schematic view of a magnetic material particle according to the present invention.

FIG. 2 is a flow diagram showing an example of a forming procedure of a metal soft magnetic material according the present invention.

FIG. 3 is a schematic view showing a method of making an organic material a disk.

FIG. 4 is a graph showing a comparison of noise level between a case where a sheet-shaped composite magnetic material formed in FIG. 2 is stuck to an electronic instrument and a case where it is not stuck.

FIG. 5 is a schematic explanatory view showing a method of forming a disk-shaped magnetic material from a thin film.

FIG. 6 is a schematic explanatory view showing a method of forming a disc-shaped magnetic material from a spherical powder particle.

FIG. 7 is a schematic view showing a surface treatment by acid with respect to the powder magnetic material formed in FIG. 5 or FIG. 6.

### DETAILED DESCRIPTION OF THE PREFERRED EMBODIMENTS

Hereinafter, embodiments of the present invention will be described with reference to the drawings.

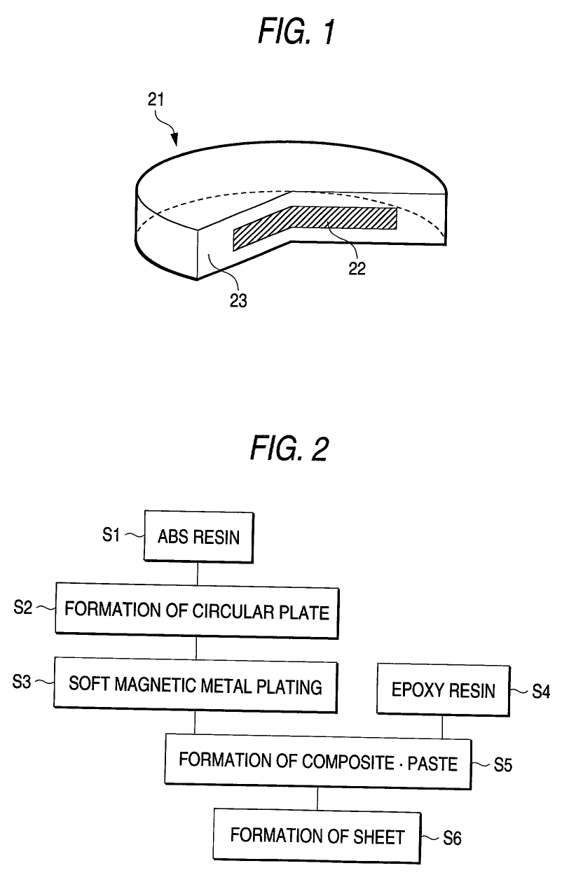

FIG. 1 is a partially cutaway schematic view of a magnetic material particle according to the present invention.

As shown in the drawing, a magnetic material particle 21 is constituted by a nucleus 22 made of organic material and a magnetic material film 23 made of metal soft magnetic material plating. Although the shape of the magnetic material particle 21 depends on the shape of the nucleus 22, the size is also changed by the thickness of the magnetic material film 23, and various composite magnetic materials can be obtained also by, for example, forming the magnetic material film 23 only on one side of the nucleus 22.

The metal soft magnetic material is a ferromagnetic material containing at least one kind of Fe, Co and Ni as ferromagnetic elements. Besides, Heusler alloy, such as Cu₂MnAl or MnAl, or the like can also be used. Alternatively, a ferromagnetic material containing Dy or Gd as a rare earth element is also included. In the present invention, any metal may be used as long as the ferromagnetic material is revealed, and the invention is not limited to the foregoing magnetic materials.

As the organic material forming the nucleus 22, it is possible to suitably select various materials such as liquid crystal polymer, epoxy resin, phenolic resin, ABS resin, plastic material, or imide resin in accordance with the soft magnetic material metal and to use it. From the gist of the present invention, limitation is not made to the foregoing organic materials.

As the shape of the nucleus 22, although a circular flat plate shape is preferable, since the resonance frequency depends on the shape of the soft magnetic material metal, an elliptical shape, a needle shape, a rod shape, a pipe shape, a lens shape, a polygonal shape or the like is conceivable. Every shape is a method for controlling the resonance frequency, and limitation is not made to the foregoing shapes. In general, if anisotropy is provided in one direction like the needle shape, there is a tendency for the resonance frequency to increase. The resonance frequency here indicates a frequency in which μ″ (term of magnetic loss) as an imaginary part of permeability takes the maximum value, and the energy of an electromagnetic wave can be effectively absorbed at this frequency.

The magnetic material film 23 is formed around the nucleus 22 by using a thin film technique such as a dry process or electroless plating. For example, in the electroless plating, it is possible to control the film thickness by the plating condition, and in the present invention, a normal thickness is controlled to be a thickness of a skin depth (skin depth) or less at a high frequency. The skin depth at this time indicates a thickness δ which follows the expression below.

δ=(2ρ/ωμ)^{½}

Where, δ: skin depth (m), ρ: resistivity (Ωm), ω: angular speed (sec⁻¹)), μ: permeability (4π×10⁻⁷ H/m).

As an example, when a Fe base material of μ=10 is magnetized at 1 GHz, the resistivity is made ρ=1×10⁻⁷ Ωm, and δ=1.6 μm is obtained. Normally, the skin depth in the case where the magnetic material is magnetized in the GHz band becomes a thickness of several μm or less.

In order to use the soft magnetic metal powder according to the present invention for the electromagnetic wave absorber, it is necessary to make a composite by using an organic binding material. In general, a metal simple substance completely reflects an electric wave and functions as a shielding material, not as an absorber. When it is combined with a suitable organic binding material, the dielectric constant becomes about 50 to 200, and an absorption effect can be exhibited while reflection of the electric wave is suppressed, so that it becomes possible to form a high performance electromagnetic wave absorber.

As the organic binding material for that, a well-known organic compound can be used. For example, although polyester resin, polyvinylchloride resin, polyurethane resin, cellulosic resin, butadiene rubber, epoxy resin, phenole resin, amide resin, imide resin, or the like can be used, since these organic binding materials are used for separating soft magnetic metals and as supporting materials, limitation is not made to the above resins.

The organic binding material and the metal soft magnetic material are mixed in the range in which the filling amount of the metal soft magnetic material is about 50 to 90 wt %, and become a paste-shaped material. In order to obtain a material for electric wave absorption by using the metal soft magnetic material of the present invention, it is necessary that the magnetic material and the organic material are substantially mixed, and the metal soft magnetic materials are separated from one another. This is because continuous, one reflector is made. The magnetic material powders of the present invention are supported in the state where they are separated from one another in the organic binding material.

As the shape of the mixed composite of the magnetic material particle and the organic binding material, a paste shape may be adopted, and it is also conceivable to work this into a sheet shape by a doctor blade method or the like. Alternatively, by using it as a mold of an IC or LSI, it is also employed for a use of preventing EMI (Electromagnetic Interference). Incidentally, the filling amount is influenced by abrasion when a flat particle is mixed, and although it is difficult to fill highly the flake-shaped flat particle having a number of protrusions, since the flat particle having a rounded surface obtained in the present invention has low frictional resistance, it is highly filled relatively easily. Accordingly, absorption efficiency becomes high. Besides, because of the flat shape, there is also a merit that arrangement of particles by natural orientation becomes apt to occur.

FIG. 2 is a flow diagram showing an example of a forming procedure of the metal soft magnetic material according to the present invention.

Since the metal soft magnetic material containing at least one kind of Fe, Co, Ni and the like has high saturated magnetization, high permeability can be expected. However, since it is metal, the melting point is as high as about 1500° C., and it is difficult to obtain a circular flat plate shape by improving a powder forming method such as atomizing. However, since the organic material has a low melting point and workability is excellent, it is easy to form a fine circular flat plate. Then, the present inventor et al considered obtaining the soft magnetic material metal of the circular flat plate shape by using, as the nucleus, the organic material by which the circular flat plate shape can be relatively easily obtained and by forming the soft magnetic material metal around the nucleus by a thin film forming method.

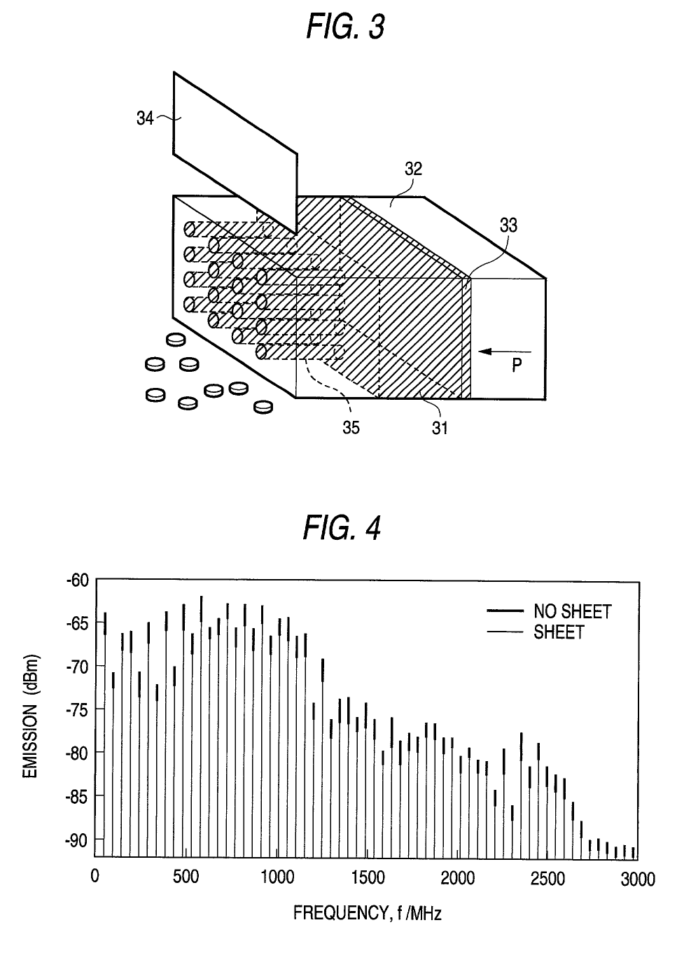

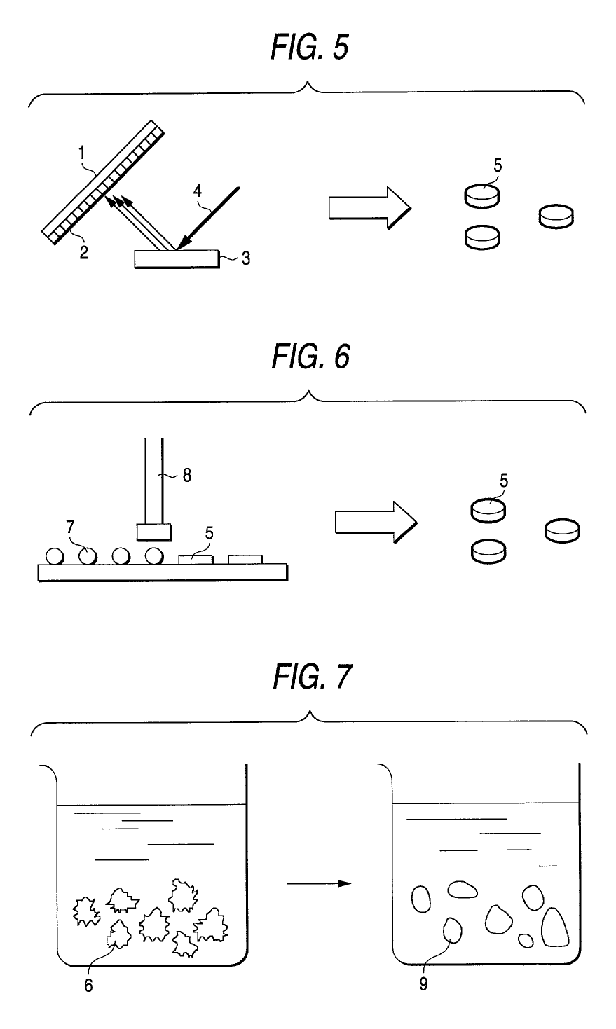

First, an ABS resin is prepared (step S1), this is made a disk by, for example, an after-mentioned method shown in FIG. 3, and a circular flat plate shape nucleus having, for example, a diameter of 40 μm and a thickness of 0.5 to 1 μm is formed (step S2). A magnetic film is formed on the circular plate nucleus of the ABS resin by a plating treatment of soft magnetic metal (step S3), and the magnetic material particle 21 shown in FIG. 1 is formed. On the other hand, an epoxy resin which becomes the organic binding material is prepared (step S4), the composite magnetic material (magnetic material particle 21) and the epoxy resin (step S4) are mixed to have a ratio of 80:20 in weight %, and a paste-shaped composite magnetic material is obtained (step S5). If necessary, a sheet-shaped composite magnetic material can be obtained by a doctor blade method (step S6).

FIG. 3 is a schematic view showing a method when the organic material at the step S2 of the flow is made a disk.

As shown in the drawing, for example, an ABS resin 31 as the organic material is filled in a container 32, the ABS resin 31 is pushed in a direction of arrow P, is successively pushed out through a cylinder 35 or a circular hole provided at a side opposite to a press surface 33, and is cut off by a blade 34 when it goes out of the side face of the container 32. In this way, the ABS resin is made the disk. Other than this method, a method of formation by a metal mold, a method of formation using a microtome, a method of punching a thin film, or the like is conceivable.

FIG. 4 is a graph showing a comparison of noise level between a case where the sheet-shaped composite magnetic material formed in FIG. 2 is stuck to an electronic instrument and a case where it is not stuck.

A thick line indicates a radiation level in the case where there is no sheet, and a thin line indicates a radiation level in the case where there is a sheet. As shown in the drawing, a sample of a sheet having a thickness of 100 μm and formed by the doctor blade method of FIG. 2 into a sheet (step S6) was stuck on an IC generating a noise having a frequency of 0 to 3 GHz, and a noise reduction effect before and after the sticking was measured. When the case where the sheet was stuck was compared with the case where the sheet was not stuck, the noise reduction effect of about 3 dB was observed, and it was confirmed that the electric wave absorption effect was high although the sheet was thin.

As described above, in the present invention, the magnetic material particle is formed by the nucleus made of the organic material and the magnetic material film formed on its surface, so that the surface of the metal soft magnetic material is easily smoothed at low cost, and a regular shape disk or elliptical shape is obtained. By this, the permeability as the electromagnetic wave absorber is increased, and the uniformity, reproducibility, and productivity of the magnetic material particle is raised. In this case, since the surface of the magnetic material particle is smoothed, the resistance for mixture is low, the filling rate to the organic binding material can be raised, and the permeability can be further raised.

What is claimed is:

1. An electromagnetic wave absorber, comprising:
a mixture of a magnetic material particle and an organic binding material,
wherein the magnetic material particle comprises a nucleus made of an organic material and a magnetic material film formed on its surface.

2. An electromagnetic wave absorber according to claim 1, wherein a film thickness of the magnetic material film is a skin depth or less.

3. An electromagnetic wave absorber according to claim 1, wherein the mixture has a paste shape or a sheet shape.
